(19) United States
(12) Patent Application Publication
(10) Pub. No.: US 2018/0122372 A1
(43) Pub. Date: May 3, 2018

(54) DISTINGUISHABLE OPEN SOUNDS

(71) Applicant: SoundHound, Inc., Santa Clara, CA (US)

(72) Inventor: Moxie Wanderlust, Los Gatos, CA (US)

(73) Assignee: SoundHound, Inc., Santa Clara, CA (US)

(21) Appl. No.: 15/339,291

(22) Filed: Oct. 31, 2016

(51) Int. Cl. G10L 15/22; G06F 3/16

(52) U.S. Cl. CPC G10L 15/22; G10L 21/0324; G06F 3/167

(57) ABSTRACT

Systems for speech enabling devices perform methods of configuring distinct open sounds for different devices to indicate to users when each device is recognizing speech. Open sounds are stored both on computer-readable media within a device and on server systems to which devices interface over networks. Open sounds are a parameter of device personalities, and can be configured by system designers, users, or service providers. Devices detect the presence of others by spotting known open phrases, and provide distinctiveness by changing their selected open phrase. Server system providers analyze non-verbal and spoken phrase open sounds from developers using audio fingerprinting and speech recognition.

### FIELD OF THE INVENTION

The invention is related to computer systems and, more specifically, to embedded systems enhanced with speech recognition.

### BACKGROUND

Ever increasing numbers of consumer devices are responsive to speech. Some examples of devices are mobile phones, tablets, watches, video gaming systems, televisions, appliances such as refrigerators, home automation and personal assistant devices, robots, and automobiles. Many such devices are “always listening”. That means, they continuously capture audio, such as through microphones, process it, and attempt to spot a specific wake-up phrase. Upon spotting the wake-up phrase, they capture a following speech utterance, and behave in a programmed responsive manner. Many such devices additionally or alternatively accept manual user input such as a tap on a touch screen, a button press, or a gesture. Either by spotting a wake-up phrase or by receiving appropriate manual input such devices detect that a user is addressing them. When such a device receives an indication that a user is addressing it, the device outputs an open sound, such as from a speaker, to indicate to users when the device is receptive to capturing the users' speech.

Many such devices use the same models of speech recognition and natural language processing subsystems for reasons such as that their speech recognition software is from the same vendor or source code repository or service is from the same back-end cloud service provider. Each speech recognition system has one or more open sounds such as a beep, boop, blip, or spoken phrases. Since multiple devices, enabled by the same speech recognition system, have the same open sound, users of multiple speech-enabled devices do not sense a distinction between them. Therefore, what is needed is a system and method that provides distinct, distinguishable, or distinguishing open sounds for speech-enabled devices.

### SUMMARY OF THE INVENTION

The present disclosure describes systems and methods for providing distinct, distinguishable, or distinguishing open sounds for speech-enabled devices. Speech-enabled devices are ones that respond in useful ways to human speech. The methods, systems, and device disclosed herein are beneficial to users by conditioning them to devices so that the users are less likely to issue commands to the wrong devices. It has a further benefit of providing a clue to help users catch their mistakes in addressing the wrong device. It has a further benefit of improving safety by helping users to avoid giving unintended, potentially dangerous commands to the wrong devices.

In accordance to the various aspects of the invention, some embodiments are devices that include a stored collection of open sounds. In accordance to the various aspects of the invention, some embodiments are servers that store a library collection of open sounds. Some servers send the open sound audio to client devices in response to a selection for each utterance request. Some servers send open sounds to devices to store on the device. In accordance to the various aspects of the invention, some embodiments are servers that provide for software developers to store multiplicities of open sounds for use in different devices.

In accordance to the various aspects of the invention, some embodiments have a close sound that is output when the system detects that a user has stopped speaking at the end of an utterance, such as after a certain period of silence. In some embodiments and devices, the close sound reverses the pattern of tones in a corresponding open sound. For example, an open sound that has musical notes of increasing pitch would correspond with a closing sound that has the same notes but in order of decreasing pitch.

In accordance to the various aspects of the invention, some embodiments allow a user to select an open sound for a device. In accordance to the various aspects of the invention, some embodiments have various parameters that give a device a perceived personality. Some or all parameters can be changed together. Some examples of personality parameters are patterns of colors or changing lights, avatars, text-to-speech (TTS) voices, wake-up phrases, natural language grammar rules, open sounds, and close sounds.

Such selection can be done through a graphical user interface menu, and can effect change either locally on the device, remotely on a server, or both. In accordance to the various aspects of the invention, some embodiments provide for a software developer, or developer of components of a speech-enabled system, to select from an array, or define custom open sounds and close sounds.

In accordance to the various aspects of the invention, some embodiments use one open sound in response to a phrase spotter, but another open sound in response to a tap on a microphone button to indicate the beginning of a user command. In accordance to the various aspects of the invention, some embodiments use one open sound for an initial address after a long period without interaction, but another open sound in response to a follow-on address during a period of recent activity. In accordance to the various aspects of the invention, some embodiments vary open spoken phrase sounds to model anthropomorphic behavior.

In accordance to the various aspects of the invention, some embodiments include a plurality of devices that are not responsive to speech, and a speech-enabled controlling device to which the plurality is responsive. Some such embodiments use open sounds stored in each of the plurality of non-responsive devices. In accordance to the various aspects of the invention, some embodiments use open sounds stored in the controlling device, but with distinct open sounds for each of the plurality of non-responsive devices.

In accordance to the various aspects of the invention, some embodiments store open sounds on non-transitory computer readable storage media such as hard disk drives, solid state drives, or embedded flash RAM. In accordance to the various aspects of the invention, some embodiments store open sounds as digital audio files in formats such as .wav, .mp3, .flacc, or other comparable formats.

In accordance to the various aspects of the invention, some embodiments use a phrase spotter, not just for detecting user addresses, but also for spotting open sounds of other devices. By doing so, a device can configure itself to ensure that it has an open sound that is distinct from other nearby devices. In accordance to the various aspects of the invention, some embodiments monitor the level of ambient noise, such as by sampling, digitizing, and computing a loudness value. Then, adjust the volume used to output the open sound such that the open sound is louder in a noisy environment and quieter in a quiet environment.

In accordance to the various aspects of the invention, some embodiments that include open sounds from different developers ensure that different developers have open sounds that are distinctive from each other and from all others. Such embodiments, when receiving a new open sound from a developer, compute a fingerprint of the sound, maintain a database of fingerprints of other open sounds, and compares for a match. If a match is found, then the system rejects the developer's new open sound and informs the developer that it is too close to another.

In accordance to the various aspects of the invention, some embodiments use open sounds that are spoken words. Some such embodiments, to ensure distinctive open sounds, perform speech recognition on the spoken words of developers' open sounds and compare the words to a database of text of speech from other open sounds.

In accordance to the various aspects of the invention, some embodiments are used for music detection, capture, or analysis. In accordance to the various aspects of the invention, some embodiments are used with speech recognition. In accordance to the various aspects of the invention, some embodiments are used with natural language processing and understanding.

### BRIEF DESCRIPTION OF THE DRAWINGS

The specification disclosed includes the drawings or figures, wherein like numbers in the figures represent like numbers in the description and the figures are represented as follows:

FIG. 1 illustrates a user speaking a wake-up phrase in the presence of three speech-enabled devices, according to an embodiment of the invention.

FIG. 2 illustrates a mobile device enabled with multiple personalities, including distinct open sounds and close sounds, according to an embodiment of the invention.

FIG. 3 illustrates a speech-enabled device connected to a server that sources open sounds, according to an embodiment of the invention.

FIG. 4 illustrates a process of selecting and outputting an open sound from a collection, according to an embodiment of the invention.

FIG. 5 illustrates a process of configuring a device with an open sound from a collection on a server, according to an embodiment of the invention.

FIG. 6 illustrates a menu for selecting an open sound from a collection of open sounds, according to an embodiment of the invention.

FIG. 7 illustrates a menu for selecting a personality from a menu, each personality having a distinct open sound, according to an embodiment of the invention.

FIG. 8 illustrates elements of a system particular to a selected personality, according to an embodiment of the invention.

FIG. 9 illustrates a process of detecting open known sounds, according to an embodiment of the invention.

FIG. 10 illustrates a process of fingerprinting new open sounds and comparing the fingerprints to a database, according to an embodiment of the invention.

FIG. 11 illustrates a process of recognizing speech in new open sounds and comparing the speech to a database, according to an embodiment of the invention.

FIG. 12 illustrates components of a computer system according to the various aspects of the invention and appropriate for implementing any embodiment of the invention.

### DETAILED DESCRIPTION

Sometimes users have multiple speech enabled devices. For example, some families have multiple mobile phones and one or more tablets, each of which can respond to the phrase, “Ok Google”. Many such devices easily detect that phrase from across a room. As a result, if a family member attempts to interact with a device using speech by waking it up with the phrase, “Ok Google”, it is possible that multiple devices will respond. They respond with a characteristic bleep sound, which indicates to users the beginning of a speech session. However, they all make the same open sound, and make it simultaneously. As a result, the user who woke up the devices with the phrase does not know which ones are listening, and might not recognize that more than one device is listening.

A large number and wide variety of devices, including many other than mobile phones and tablets, are speech enabled. A small number of system providers enable the speech recognition and natural language processing for the wide variety of devices. Households, workplaces, and places of retail and entertainment that have multiple devices, when the devices use default open sounds of common providers, leave users confused as to which device they control.

When devices have different open sounds, they give a subconscious clue as to which device is listening. By providing for different devices to have different open sounds, according to the invention, it is clear to users which device is listening when multiple might be awake.

People with multiple speech-enabled devices also sometimes invoke the wrong one. Having distinct open sounds, provides a subconscious reminder by notifying the user as to the identity of the device. This helps users notice their mistakes before issuing meaningless, incorrect, or dangerous commands. In effect, the open sound of a device is part of its personality. The system and devices described herein are computer based systems and method. As recognized by those skilled in the art, the conversion of spoken words to digital data, that is then analyzed, and the conversion of digital data into speech in order to provide information to a user is not abstract in concept, but rather significant improvement in technology according to the various aspects and embodiment of the invention as set forth herein.

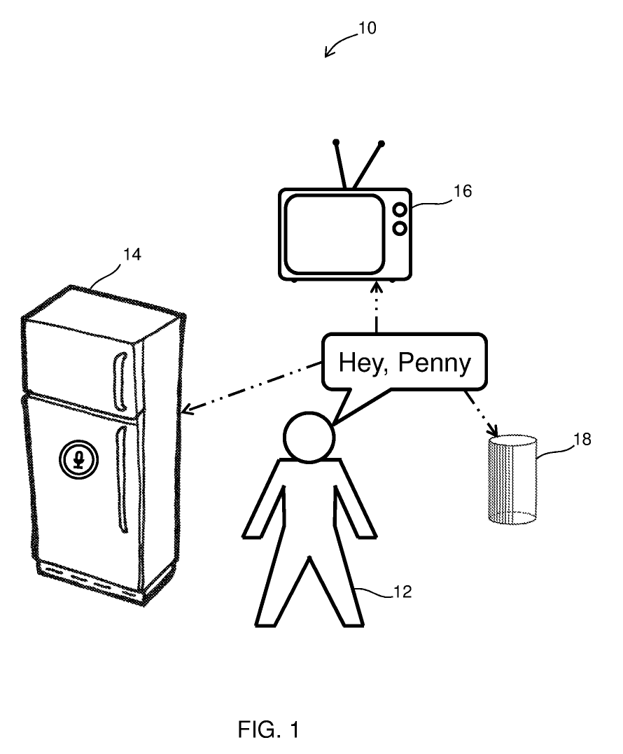

FIG. 1 shows usage of an embodiment of the invention. Within a room 10, a user 12 is able to interact with three speech-enabled devices with distinct open sounds, according to embodiments of the invention. One embodiment is a Sibsung brand refrigerator 14 that spots the wake-up phrase “Hey, Sammy” and has a microphone button for users to indicate an intended address. Refrigerator 14 outputs an open sound that is speech audio saying, “How may I serve you?” followed by a beep. One embodiment is a Panasoney brand TV set 16 that spots the wake-up phrase, “Okay, Penny” and recognizes a hand waving gesture to indicate a user address. TV set 16 outputs an open sound that is speech audio saying, “What's up?” followed by a boop. One embodiment is an Alibazon brand virtual shopper cylinder 18 that spot the wake-up phrase, “Hey, Ali”. Virtual shopper 18 outputs an open sound that is speech audio saying, “Good morning.” if the local time is morning, “Good afternoon.” if the local time is afternoon, and “Good evening.” if the local time is evening, followed by a blip.

Each of refrigerator 14, TV set 16, and virtual shopper 18 including a computer processor and non-volatile memory. The memory in each device stores digital audio segments that, when output through a speaker, makes its characteristic open sound.

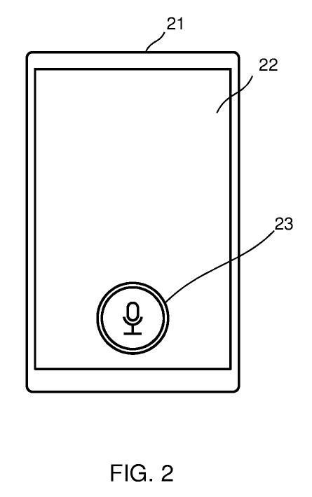

FIG. 2 shows an embodiment in the form of a tablet computer 21. It has a display 22 that shows a microphone button 23. Tablet 21 also spots for wake-up phrases. When a user taps the microphone button or speaks a wake-up phrase, tablet 21 begins a session in which the user can provide speech utterances. At the beginning of a session, tablet 21 sends a message to a server; the server responds with an open sound audio segment; and the tablet outputs the audio segment to signal to the user that the session is open.

Tablet 21 also has storage that stores a collection of open sounds. In accordance with the various aspects and embodiments of the invention, a default collection is part of the device operating system. Various distinct speech-enabled apps invoke different open sounds from the collection. App developers may choose which open sound from the collection to use for their apps, may add their own open sound to the tablet and use their own, or provide a menu that allows tablet users to choose an open sound.

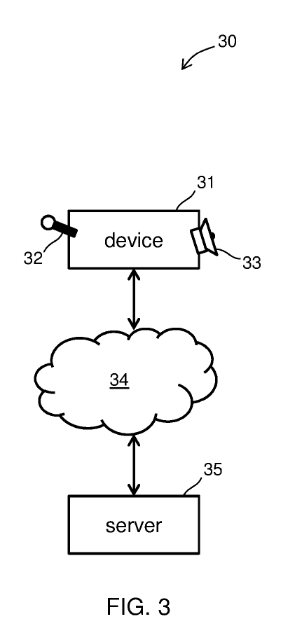

FIG. 3 shows a system of a device that gets open sounds from a server. System 30 includes a device 31, which captures user speech using a microphone 32, and outputs audio, including open sounds, to the user through speaker 33. Device 31 corresponds through a network 34, such as the Internet. The network 34 couples device 31 with a server 35. The device 31 stores a local cache of open sounds. For each user session, the device 31 sends a request to the server 35. The server responds with an open sound. The device 31 stores the open sound in its cache. For all user speech interactions with the device 31, the device 31 outputs the cached open sound. After a user session ends, such as after a period of five minutes with no speech interaction, the device 31 marks the cached open sound as stale.

In various systems, it is possible for numerous devices to interact with a server. It is also possible for a device to interact with different servers, to provide its own local speech-enablement, or provide a combination of local or server-based speech enablement.

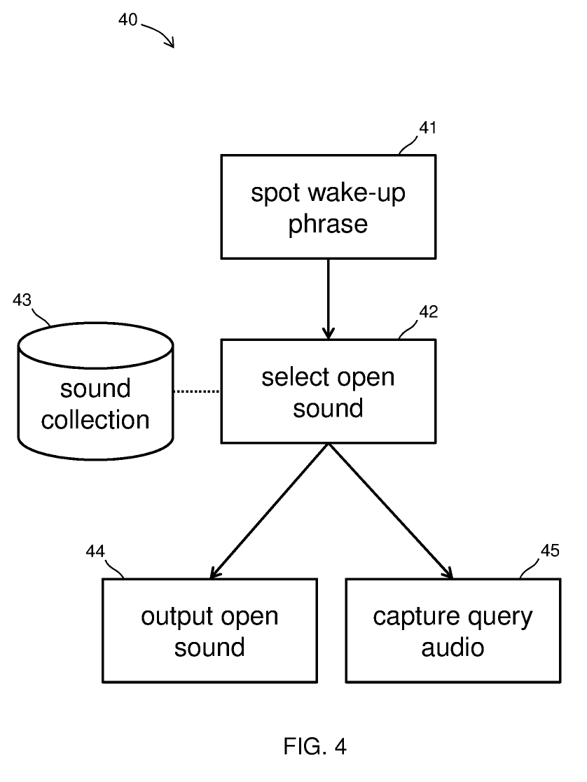

FIG. 4 shows a process 40 of speech enablement in accordance with various aspects and an embodiment of the invention. The process begins at step 41 when a system spots a wake-up phrase. At step 42, the system proceeds to select an open sound from a plurality of open sounds stored in memory or database and includes a collection of open sounds 43. In some embodiments, the selection is by the design of the device that incorporates the speech enablement system. In some embodiments, the selection is a device configuration choice made by a user. In some embodiments, a third party content provider makes the selection. Some embodiments store open sound collection 43 in storage or memory located on a user device. Some embodiments store open sounds on a cloud computing server. Any storage location is appropriate and in accordance with the various aspects and embodiments of the invention.

After step 42 of selecting an open sound, process 40 proceeds to step 44 and outputs the open sound and step 45 to begin capturing audio for a user query. In some embodiments, the steps of outputting an open sound and capturing query audio are sequential.

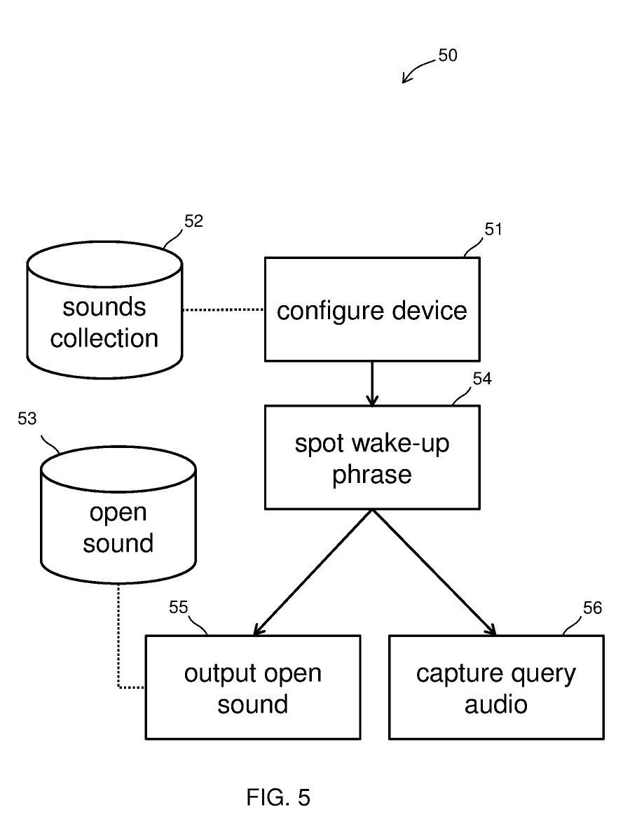

FIG. 5 shows a process 50 of speech enablement according to various aspects and an embodiment of the invention. The process begins by a step 51 that includes configuring a device to use one sound selected from a collection of sounds 52. Process 50 proceeds to take the sound selected during step 51 for device configuration and stores it as open sound 53. In some embodiments, the configuration step 51 happens during the design of a system. In some embodiments, the configuration step 51 happens during manufacturing of a system. In some embodiments, the configuration step 51 happens as part of a retail sales process. Some such retail sales processes are those of online retailers, ringtone sales, app stores, and speech-based purchasing systems. In some embodiments, the configuration step 51 happens as part of a user set. In some embodiments, the configuration step 51 happens through in-field firmware updates.

The process 50 proceeds to step 54, for every user session, to spot a wake-up phrase; to step 55 to output the open sound; and to step 56 for capture user query audio 56.

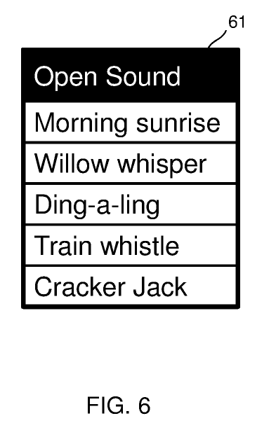

FIG. 6 shows a system menu according to an embodiment. Open Sound menu 61 is part of a graphical user interface (GUI). It allows a user to select one of five open sounds in a collection. The number of open sounds in the collection can be varied to more or fewer open sounds. The open sounds have vaguely descriptive names with pleasing connotations. They are the audio equivalent of the names of house paint colors.

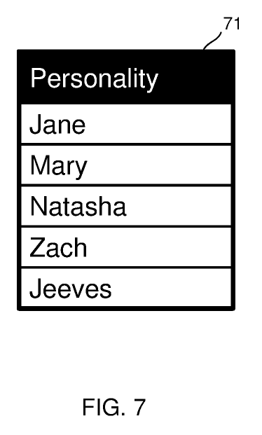

Some embodiments are devices that have personalities. FIG. 7 shows a personality selection menu for such an embodiment. Personality menu 71 offers five choices of personalities. The number of personalities can vary to more or fewer open sounds. Each has an anthropomorphic name that is very vaguely descriptive of a personality. Various elements of a system contribute to its anthropomorphic personality.

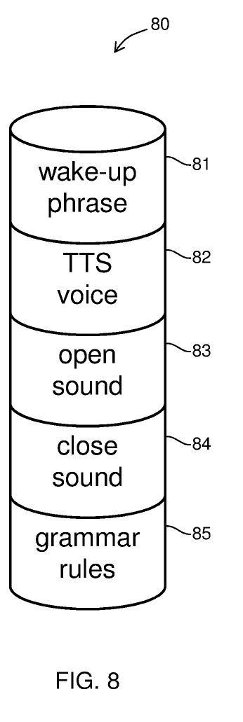

FIG. 8 shows a set of elements 80 that are stored as part of a device personality. Wake-up phrase 81 defines how a user invokes a session with the device, and is typically a phrase beginning with “Okay” or “Hey”, followed by a two or three syllable name that is anthropomorphic, but uncommon. Text-to-speech (TTS) voice 82 defines a voice that the system uses to output verbal communication to users. Most TTS voices are distinctly male or female, and have distinct accents and patterns of intonation. Open sound 83 and close sound 84 are the audio used to indicate the beginning and ending of a speech session between the user and system. Open sounds and close sounds can have short non-verbal audio segments such as beeps, boops, blips, dings, whooshes, whistles, snaps, cracks, pops, or other appropriate sounds. Open and close sounds can, alternatively or additionally, have spoken phrase audio. Grammar rules 85 are the vocabulary, word patterns, rules for interpretation, and domains of knowledge that the system may use to understand user speech.

Some embodiments use multiple open sounds for the same device. This is particularly useful if the open sounds are spoken phrases. Humans tend to vary their responses, when addressed, based on the situation, conditions, or mood. By a device varying the spoken phrase open sound, users perceive it as more anthropomorphic. Some embodiments of systems that provide different open sounds from the same device provide for customizing the set of open sounds from which the system can choose. For example, a refrigerator might randomly switch between spoken phrase open sounds saying, “How may I serve you?”, and “What would you like?”, whereas a television, when its display is off, uses the spoken phrase open sound, “What would you like to see?”, and, when the display is on, tersely say, “Yes?”.

For some types of devices, it is not convenient or practical for users to configure the device personality or open sound, such as from a menu. Some embodiments, such as devices that might be placed within speaking distance of others of the same model, need to avoid the problem of having the same open sound.

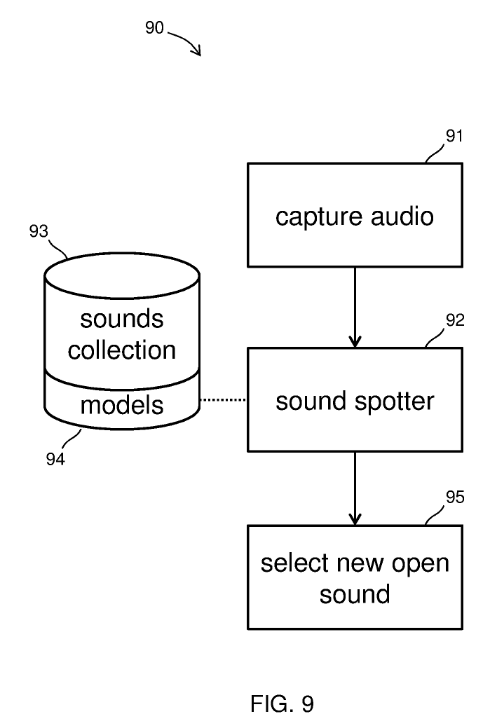

FIG. 9 shows a process for such embodiments to do so. Process 90 includes step 91 for continuously capturing ambient audio. Next the system performs sound spotting at step 92. This is performed using the same neural network, trained on audio segments for small vocabulary speech recognition, that the system uses for wake-up phrase spotting. The training for sound spotter step 92 is done a priori from a collection of sounds 93 used to create acoustic model 94. When, at sound spotter step 92, the device spots captured audio, from step 91, that corresponds to a sound from the sound collection 93, if the sound matched in sounds collection 93 is the same as the system's currently selected open sound then the system proceeds to select a new open sound at step 95.

Some embodiments select a new open sound by choosing the next on a list of open sounds. Some embodiments select an open sound randomly from the sounds collection. Some embodiments select not just an open sound, but an entire personality. By doing so, similar model devices automatically become distinct from each other within a shared audible environment.

Some embodiments are shared systems, such as ones based on cloud servers, which support many types of devices. Device and interface designers using such systems create their own open and close sounds and upload them to the shared system. It is desirable to ensure that different designers have distinct open sounds, or at least similar types of devices, such as ones from competitors serving the same end-user markets, have distinct open sounds.

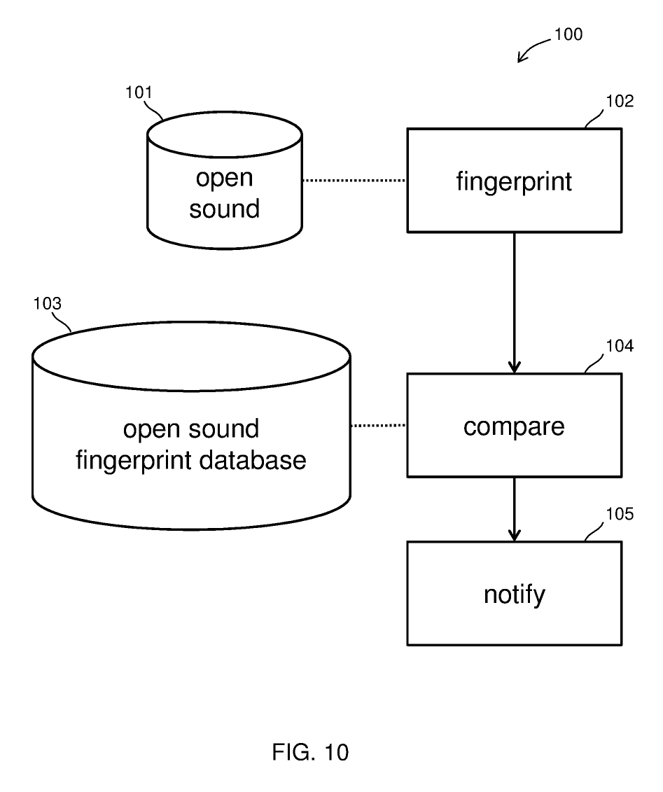

FIG. 10 shows an embodiment that provides for such distinctiveness. The system performs process 100, which begins when the system receives a new open sound 101. The system, at step 102, computes a fingerprint of the open sound 101. The system also stores a database of all known device open sounds database 103. In step 104, the system proceeds to compare the fingerprint from step 102 to fingerprints from database 103 using a known method of fingerprint comparison, for example, as used for music recognition. If the system detects a match between the fingerprint of new open sound 101 and a fingerprint stored in database 103, then the process proceeds, at step 105, to notify the user and the system operator of the overlap between the open sound 101 and the fingerprint in the database 103. Some systems automatically reject a new open sound and refuse to provide it to supported devices.

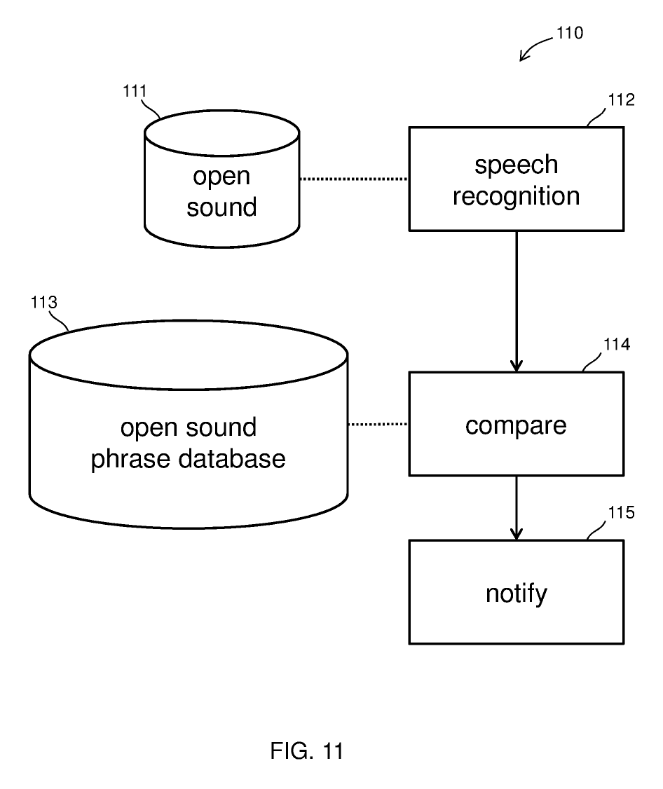

Some embodiments of shared systems, additionally or alternatively, enforce distinctiveness between spoken phrase open sounds. FIG. 11 shows one such embodiment. Process 110 begins by receiving open sound 111. It performs a speech recognition, at step 112, using a known method of speech recognition. Process 110 proceeds to search a sound phrase database 113, which includes textual representations of speech recognized from each stored open sound. At step 114, the system compares the speech recognized, at step 112, to the phrases in the sound phrase database 113. If a phrase in the database is sufficiently similar to speech recognized from open sound 111, then process 110 proceeds to step 115 and refuses to accept the open sound 111 and notifies the developer and system operator.

Some embodiments perform simple text string matching. Some embodiments perform fuzzy matching between the recognized speech and speech in the phrase database. Some embodiments include word synonyms in the search. Some embodiments perform natural language understanding algorithms on the speech and compare speech intents. Some embodiments, if they detect no spoken words in speech recognition step 112 exit the process without comparison step 114. Some embodiments check recognized speech text for trademarked names and profane language.

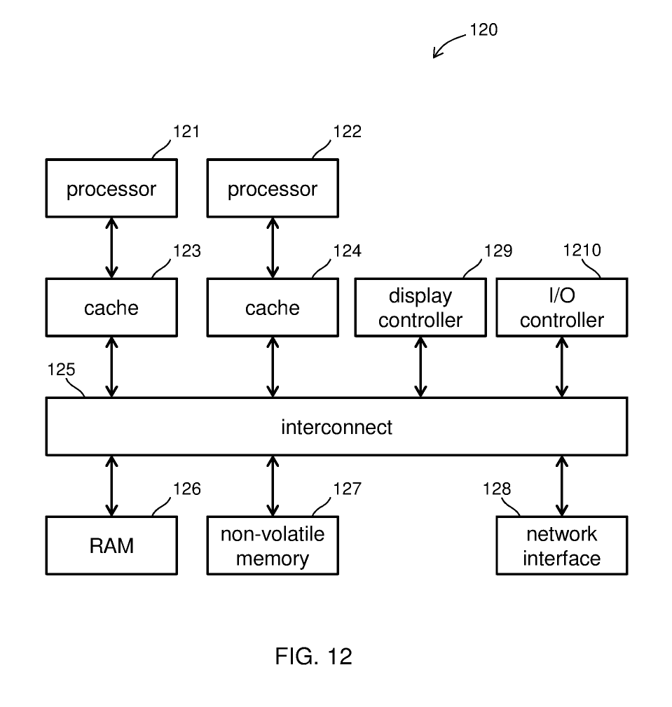

Some embodiments are implemented in software that runs on computer processors. One such embodiment is shown in FIG. 12. Computer system 120 includes parallel processors 121 and 122, which connect through caches 123 and 124, respectively, to interconnect 125, through which the processors can execute software from instructions and operate on data stored in random access memory (RAM) 126 and non-volatile memory 127. Software running on computer system 120 accesses the Internet through network interface 128, provides a GUI through display controller 129, and accepts user input through I/O controller 1210, all of which are also connected through interconnect 125.

In some embodiments, the processors are ARM instruction set processors. In some embodiments they are x86 processors. In some embodiments, memories, controllers, and interfaces are all on the same system-on-chip. In some embodiments, some elements are in different chips. In some embodiments, the non-volatile memory is a hard disk drive. In some embodiments, it is a solid-state drive. In some embodiments, the display controller connects to a local device display panel through a mobile industry processor interface (MIPI) display serial interface (DSI). In some embodiments, the display controller connects to a HDMI connector. In various embodiments, the I/O controller interfaces to touch screens, keyboards, mice, microphones, speakers, and USB connectors. In various embodiments, the network interface is an Ethernet cable interface, WiFi interface, Bluetooth interface, and 5G LTE interface.

In some embodiments, receiving and transmitting between clients and servers is through direct connections. In some embodiments, clients and servers are coupled through intermediate media, such as busses or computer networks, and receiving and transmitting are indirect.

Embodiments of the invention described herein are merely exemplary, and should not be construed as limiting of the scope or spirit of the invention as it could be appreciated by those of ordinary skill in the art. The disclosed invention is effectively made or used in any embodiment that comprises any novel aspect described herein. All statements herein reciting principles, aspects, and embodiments of the invention are intended to encompass both structural and functional equivalents thereof. It is intended that such equivalents include both currently known equivalents and equivalents developed in the future.

The behavior of either or a combination of humans and machines (instructions that, when executed by one or more computers, would cause the one or more computers to perform methods according to the invention described and claimed and one or more non-transitory computer readable media arranged to store such instructions) embody methods described and claimed herein. Each of more than one non-transitory computer readable medium needed to practice the invention described and claimed herein alone embodies the invention.

Some embodiments of physical machines described and claimed herein are programmable in numerous variables, combinations of which provide essentially an infinite variety of operating behaviors. Some embodiments of hardware description language representations described and claimed herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines, such as semiconductor chips; hardware description language representations of the logical or functional behavior of machines according to the invention described and claimed; and one or more non-transitory computer readable media arranged to store such hardware description language representations all can embody machines described and claimed herein.

In accordance with the teachings of the invention, a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the invention, therefore, is not intended to be limited to the exemplary embodiments shown and described herein. Rather, the scope and spirit of present invention is embodied by the appended claims.

1. A non-transitory computer readable medium storing code that, when executed by one or more processors would cause the one or more processors to:
receive input indicative of a selection of one of a plurality of distinguishable open sounds to be used for indicating that a system is receptive to a user query;
capture audio through a microphone;
digitize the audio into audio samples;
perform sound spotting using a neural network algorithm on the audio samples, the neural network trained for a specific wake-up phrase;
in response to the neural network spotting the specific wake-up phrase, receive speech input through the microphone, the speech input including an audible user query;
further in response to spotting the specific wake-up phrase, read an open sound audio segment, corresponding to the selection, from a storage device; and
output, through a speaker, the open sound audio segment indicating that a system is receptive to capturing the user's speech,
wherein the user is able to distinguish between at least two speech enabled devices within a shared audible environment.

2. The non-transitory computer readable medium of claim 1, wherein the code, when executed by one or more processors, would cause the one or more processors to:
receive an end of utterance input indicating an end of utterance; and
responsive to receiving the end of utterance input, read a close sound audio segment corresponding to the selection.

3. The non-transitory computer readable medium of claim 1, wherein the input indicative of the selection is an input from the user.

4. The non-transitory computer readable medium of claim 1, wherein the input indicative of a selection is also indicative of a selection of at least one of a plurality of wake-up phrases.

5. The non-transitory computer readable medium of claim 1, wherein the code, when executed by one or more processors, would cause the one or more processors to:
receive an audio signal; and
compare the audio signal to at least one alternative open sound audio segment,
wherein the input indicative of the selection is conditioned upon not matching the audio signal to the at least one alternative open sound audio segments.

6. The non-transitory computer readable medium of claim 1, wherein the code, when executed by one or more processors, would cause the one or more processors to:
receive ambient sound;
compute loudness of the ambient sound; and
adjust volume of the open sound audio segment output in response to the loudness of the ambient sound.

7. The non-transitory computer readable medium of claim 1, wherein the code, when executed by one or more processors, would cause the one or more processors to:
provide, to the user, a menu of names corresponding to open sounds selected from the plurality of open sounds,
wherein the input indicative of a selection of one of a plurality of open sounds is the user's selection from the menu.

8. A non-transitory computer readable medium storing code that, when executed by one or more processors would cause the one or more processors to:
receive a client request for an open sound selected from a plurality of distinguishable open sounds, the open sound to be used as an indication that the client is receptive to a user's query;
according to an indication of which of the plurality of open sounds, read a corresponding open sound audio segment; and
transmit the open sound audio segment to the client;
capture audio through a microphone;
digitize the audio into audio samples;
perform sound spotting on the audio samples to detect a specific wake-up phrase;
in response to detecting the specific wake-up phrase, output the open sound audio segment, through a speaker, indicating that the client is receptive to capturing the user's speech,
wherein the user is able to distinguish between at least two speech enabled devices within a shared audible environment.

9. The non-transitory computer readable medium of claim 8, wherein the code, when executed by the one or more processors, would also cause the one or more processors to determine the indication from the client request.

10. The non-transitory computer readable medium of claim 8, wherein the code, when executed by the one or more processors, would also cause the one or more processors to:
store the indication; and
read the indication.

11. The non-transitory computer readable medium of claim 8, wherein the code, when executed by the one or more processors, would also cause the one or more processors to ensure that a plurality of types of device, each has a unique open sound audio segment.

12. The non-transitory computer readable medium of claim 11, wherein the code, when executed by the one or more processors, would also cause the one or more processors to:
compare each of a plurality of sound audio segments;
compute a difference score for each comparison; and
provide a notification to a system operator responsive to the difference score being below a threshold.

13. The non-transitory computer readable medium of claim 12, wherein the code, when executed by the one or more processors, would also cause the one or more processors to:
transcribe speech from a plurality of sound audio segments; and
include the transcription in the comparison.

14. A natural language virtual assistant server system enabled to:
receive and store at least one domain-specific natural language grammar from a first developer;
receive and store at least one open sound selected from a plurality of distinguishable open sounds from the first developer;
receive and store at least one domain-specific natural language grammar from a second developer;
receive and store at least one open sound selected from the plurality of distinguishable open sounds from the second developer, the at least one open sound of the first developer being distinguishably different from the at least one open sound of the second developer;
read and transmit the first open sound to a first device, the first device having a first wake-up phrase; and
read and transmit the second open sound to a second device;
capture audio through a first microphone of the first device and through a second microphone of the second device;
digitize the audio into an audio sample;
perform sound spotting on the audio sample at the first device and the second device, to determine if there is a match between the audio sample and at least one of the first wake-up phrase and the second wake-up phrase; and
in response to determining a match between the audio sample and at least one of the first wake-up phrase and the second wake-up phrase, activate one of the first device and the second device to output through that device's speaker the corresponding open sound indicating that the corresponding device is receptive to capturing speech,
wherein a user is able to distinguish between the first device and the second device within a shared audible environment based on the device's corresponding open sound.
